(19) United States
(12) Patent Application Publication
(10) Pub. No.: US 2020/0303858 A1
(43) Pub. Date: Sep. 24, 2020

(54) CONNECTOR

(71) Applicant: Sumitomo Wiring Systems, Ltd., Yokkaichi,Mie (JP)

(72) Inventor: Hiroshi Inoue, Yokkaichi, Mie (JP)

(21) Appl. No.: 16/086,021

(22) PCT Filed: Mar. 2, 2017
(86) PCT No.: PCT/JP2017/008208

§ 371 Date: Sep. 18, 2018

(30) Foreign Application Priority Data
Mar. 23, 2016 (JP) 2016-058054

(51) Int. Cl. H01R 13/428; H01R 13/11; H01R 43/16

(52) U.S. Cl. CPC H01R 13/428; H01R 43/16; H01R 13/114

(57) ABSTRACT

A connector includes a housing (10) formed with a terminal accommodation chamber (11), and a female terminal fitting (30) with a rectangular tubular terminal body (31) is inserted into the terminal accommodation chamber (11). A resiliently deflectable locking lance (15) is formed in the terminal accommodation chamber (11) and retains the female terminal fitting (30) in the terminal accommodation chamber (11) by locking the terminal body (31). A resilient contact piece (44) is provided inside the terminal body (31) and resiliently contacts a tab (51) of a male terminal fitting (50) inserted into the terminal body (31). A resilient pressing portion (40) is formed on an outer surface of the terminal body (31), and a pressure receiving portion (18) on an inner wall of the terminal accommodation chamber (11) is configured to achieve resilient contact with the resilient pressing portion (40).

### BACKGROUND

### Field of the Invention

The invention relates to a connector.

### Related Art

Japanese Unexamined Patent Publication No. 2015-230857 discloses a connector with a housing formed with a terminal accommodation chamber. The connector also has a female terminal fitting to be inserted into the terminal accommodation chamber. A resiliently deformable locking lance is formed at an inner wall of the terminal accommodation chamber. The female terminal fitting includes a terminal body in the form of a rectangular tube formed with a locking hole. The female terminal fitting inserted into the terminal accommodation chamber is retained and held by locking the locking hole to the locking lance. A resilient contact piece is provided in the terminal body and a tab of a male terminal fitting inserted into the terminal body portion is connected to the female terminal fitting while being resiliently sandwiched between a wall of the terminal body and the resilient contact piece.

In the above connector, a tiny clearance is secured between an inner wall surface of the terminal accommodation chamber and an outer surface of the terminal fitting to reduce sliding resistance when inserting the terminal fitting into the terminal accommodation chamber. Thus, if the connector is used in an environment subject to vibration, the female terminal fitting vibrates in the terminal accommodation chamber and a contact pressure varies between the female terminal fitting and the male terminal fitting. Accordingly, contact reliability may be reduced.

The invention was completed on the basis of the above situation and aims to improve contact reliability.

### SUMMARY

The invention is directed to a connector with a housing formed with a terminal accommodation chamber. The connector also has a female terminal fitting including a rectangular tubular terminal body that is to be inserted into the terminal accommodation chamber. The terminal body includes a base plate and first and second side plates rising substantially at a right angle from both sides of the base plate. A resiliently deformable resilient plate is connected to one end of the first side plate in the front-rear direction and is cantilevered toward the second end part in the front-rear direction substantially in parallel to the base plate. A supporting plate extends substantially parallel to the base plate from the second side plate and is configured to support an extending end part of the resilient plate from inside, and the resilient pressing portion is formed integrally to the resilient plate. A resiliently deflectable locking lance is formed in the terminal accommodation chamber and is configured to retain the female terminal fitting in the terminal accommodation chamber by locking the terminal body. A resilient contact piece is provided inside the terminal body and is configured to resiliently contact a tab of a male terminal fitting inserted into the terminal body. A resilient pressing portion is formed on an outer surface of the terminal body, and a pressure receiving portion is formed on an inner wall of the terminal accommodation chamber. The pressure receiving portion is configured so that the resilient pressing portion is brought resiliently into contact therewith.

The resilient pressing portion of the terminal fitting resiliently contacts the pressure receiving portion of the terminal accommodation chamber. Thus, the vibration of the female terminal fitting in the terminal accommodation chamber is prevented. Since a contact state of the resilient contact piece and the tab is stabilized in this way, contact reliability is excellent. Further, since the extending end part of the resilient plate formed with the resilient pressing portion is supported from inside by the supporting plate, a sufficient resilient pressing force of the resilient pressing portion to the pressure receiving portion can be ensured.

A contacting direction of the resilient pressing portion with the pressure receiving portion may be substantially parallel to a contacting direction of the resilient contact piece with the tab. According to this configuration, a contact pressure of the resilient contact piece and the tab is stabilized.

The female terminal fitting may be inserted into the terminal accommodation chamber from behind the housing, and a retaining projection may be formed at a position adjacent to a rear end of the pressure receiving portion and may be configured to lock the resilient pressing portion when the female terminal fitting is inserted properly. According to this configuration, the female terminal fitting can be retained reliably by two locking means, i.e. the locking lance and the retaining projection.

An interference avoiding portion may be formed in an area connected behind the retaining projection and may define a larger height difference from the retaining projection than the pressure receiving portion. According to this configuration, sliding resistance between the interference avoiding portion and the resilient pressing portion is reduced until the resilient pressing portion contacts the retaining projection in the process of inserting the female terminal fitting into the terminal accommodation chamber. Thus, workability is good.

The resilient pressing portion and the retaining projection may be locked via a retaining tapered surface inclined with respect to an inserting direction of the female terminal fitting. According to this configuration, the resilient pressing portion and the retaining projection are semi-locked. Thus, it is not necessary to use a tool or the like for disengaging the resilient pressing portion from the retaining projection when withdrawing the female terminal fitting from the terminal accommodation chamber.

An inserting tapered surface may be formed on at least one of a front surface of the resilient pressing portion and a rear surface of the retaining projection and may be inclined with respect to an inserting direction of the female terminal fitting. According to this configuration, resistance when the resilient pressing portion passes over the retaining projection is reduced in the process of inserting the female terminal fitting.

### BRIEF DESCRIPTION OF DRAWINGS

FIG. 1 is a side view in section showing a state where a female terminal fitting is inserted properly in a terminal accommodation chamber in a connector of one embodiment.

FIG. 2 is a side view in section showing the process of inserting the female terminal fitting into the terminal accommodation chamber.

FIG. 3 is a front view of the female terminal fitting.

FIG. 4 is a right side view of the female terminal fitting.

FIG. 5 is a left side view of the female terminal fitting.

FIG. 6 is a plan view of the female terminal fitting.

FIG. 7 is a side view in section of the female terminal fitting.

### DETAILED DESCRIPTION

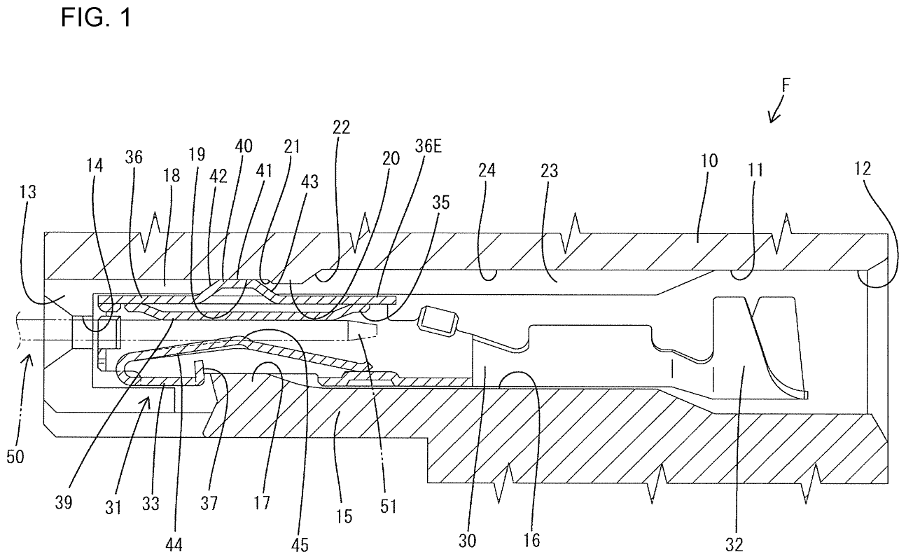

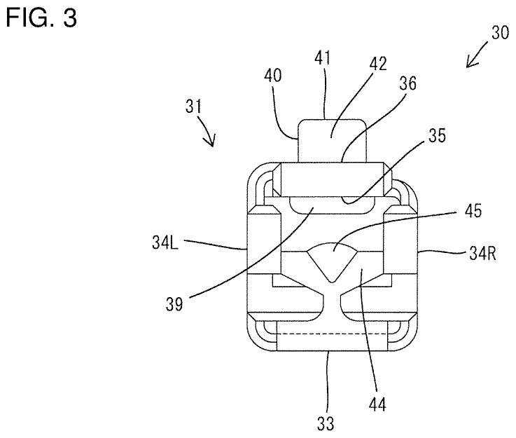

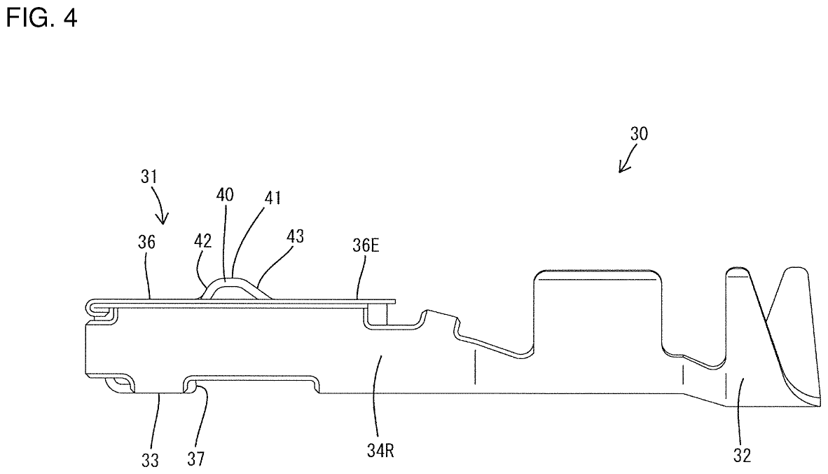

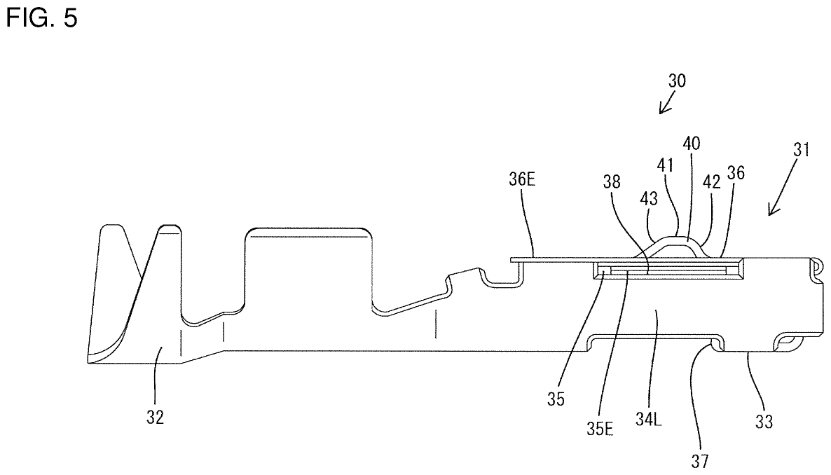

Hereinafter, one specific embodiment of the present invention is described with reference to FIGS. 1 to 7. A connector F of this embodiment includes a housing 10 made of synthetic resin and a female terminal fitting 30. Note that, in the following description, a left side in FIGS. 1, 2, 4 and 6 is defined as a front side concerning a front-rear direction. Upper and lower sides shown in FIGS. 1 to 5 are directly defined as upper and lower sides concerning a vertical direction. Left and right sides shown in FIG. 3 are directly defined as left and right sides concerning a lateral direction.

### <Housing 10>

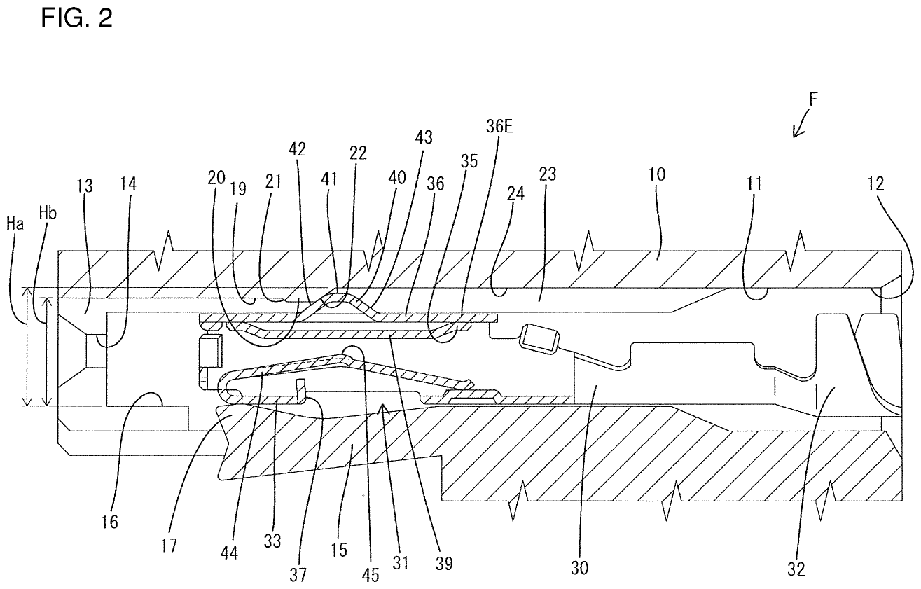

As shown in FIGS. 1 and 2, a terminal accommodation chamber 11 long and narrow in the front-rear direction is formed inside the housing 10. A rear end part of the terminal accommodation chamber 11 serves as a terminal insertion opening 12, which is an entrance in inserting the female terminal fitting 30 into the terminal accommodation chamber 11. A front part of the terminal accommodation chamber 11 has a front wall 13 for stopping the female terminal fitting 30 properly inserted into the terminal accommodation chamber 11. A tab insertion opening 14 penetrates through the front wall 13, and a tab 51 on the tip of a male terminal fitting 50 to be connected to the female terminal fitting 30 is inserted into the terminal accommodation chamber 11 through the tab insertion opening 14.

A locking lance 15 is cantilevered forward from a lower wall in the terminal accommodation chamber 11. The locking lance 15 constitutes a part of the lower wall. An area of the lower wall where the locking lance 15 is not formed functions as a terminal receiving surface 16 for supporting the female terminal fitting 30 from below. A locking projection 17 is formed on the upper surface (surface facing the terminal accommodation chamber 11) of the locking lance 15. The locking lance 15 normally is held at a locking position where the locking projection 17 is located in the terminal accommodation chamber 11, but is resiliently deformable to retract the locking projection 17 down from the terminal accommodation chamber 11.

As shown in FIG. 1, a pressure receiving portion 18 is formed on a front part of an upper wall of the terminal accommodation chamber 11. The pressure receiving portion 18 is disposed in a central part of the upper wall in the lateral direction and is recessed into a groove extending in the front-rear direction. A downward facing ceiling surface of the pressure receiving portion 18 serves as a pressure receiving surface 19 parallel to an inserting direction of the female terminal fitting 30 and the upper surface of the lower wall. The pressure receiving portion 18 and the locking projection 17 are at substantially the same position in the front-rear direction.

A trapezoidal retaining projection 20 projects farther toward the terminal accommodation chamber 11 than the pressure receiving surface 19 in a side view is formed at a position of the upper wall adjacent to the rear end of the pressure receiving portion 18. A downward facing surface of the retaining projection 20 is a flat surface parallel to the pressure receiving surface 19. The front surface of the retaining projection 20 serves as a retaining tapered surface 21 inclined with respect to the front-rear direction (direction parallel to a moving direction in inserting the female terminal fitting 30 into the terminal accommodation chamber 11). As shown in FIGS. 1 and 2, the retaining tapered surface 21 is inclined down toward a rear side. The rear surface of the retaining projection 20 serves as an inserting tapered surface 22 inclined with respect to the front-rear direction. The inserting tapered surface 22 is inclined up toward the rear.

An interference avoiding portion 23 is formed in an area of the upper wall behind the retaining projection 20. Similar to the pressure receiving portion 18, the interference avoiding portion 23 is disposed in a central part of the upper wall in the lateral direction (width direction) and is in the form of a groove extending in the front-rear direction. The interference avoiding portion 23 has a downwardly facing non-interfering surface 24 that extends parallel to the inserting direction of the female terminal fitting 30 into the terminal accommodation chamber 11 and faces the upwardly facing terminal receiving surface 16 of the lower wall, in a manner similar to the pressure receiving surface 19. A height difference between the non-interfering surface 24 and the downward facing surface of the retaining projection 20 is larger than that between the pressure receiving surface 19 and the downward facing surface of the retaining projection 20. Thus, as shown in FIG. 2, a height Ha of the non-interfering surface 24 is larger than a height Hb of the pressure receiving surface 19 with respect to the terminal receiving surface 16.

### <Female Terminal Fitting 30>

The female terminal fitting 30 is formed by applying bending and the like to a metal plate material (not shown) stamped into a predetermined shape and is long and narrow in the front-rear direction. A rectangular tubular terminal body 31 is at the front part of the female terminal fitting 30. A crimping portion 32 is at a rear part of the female terminal fitting 30 and is in the form of an open barrel for conductively fixing a wire (not shown).

As shown in FIGS. 1 and 3, the terminal body 31 includes a base plate 33 that is long and narrow in the front-rear direction, a right side plate 34R, a left side plate 34L, a supporting plate 35 and a resilient plate 36. The base plate 33 is formed with a locking hole 37 that is lockable to the locking projection 17 of the locking lance 15. The locking projection 17 of the locking lance 15 is locked to the locking hole 37 when the female terminal fitting 30 is inserted properly into the terminal accommodation chamber 11, and the female terminal fitting 30 is retained and held with a rearward movement restricted by this locking action. The left side plate 34L extends up substantially at a right angle from a left side edge of the base plate 33. The right side plate 34R extends up substantially at a right angle from a right side edge of the base plate 33.

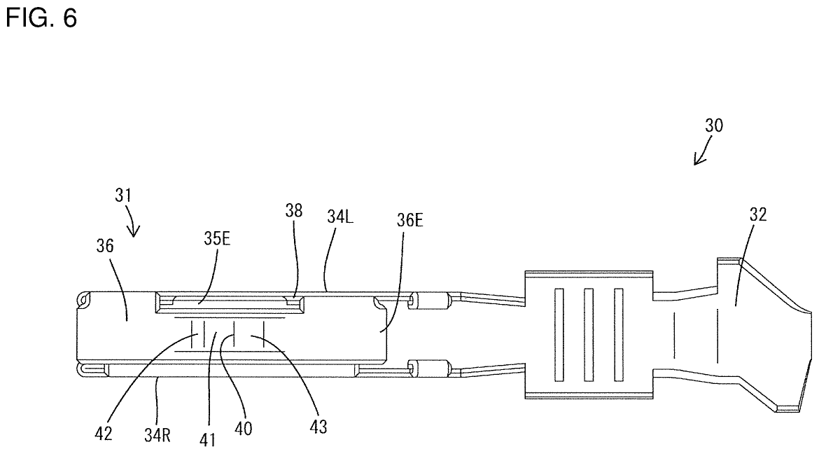

The supporting plate 35 is cantilevered substantially at a right angle from a substantially entire length area of the upper end of the right side plate 34R and is disposed to face substantially in parallel to the base plate 33. A part of an extending end edge (left end edge) of the supporting plate 35 serves as a locking edge 35E, and, as shown in FIG. 6, the locking edge 35E is locked to and placed on a receiving recess 38 formed on the upper end edge of the left side plate 34L. By this locking, the supporting plate 35 is held at a predetermined height with a downward displacement into the terminal body 31 restricted.

As shown in FIG. 1, a squeezing portion 39 projects toward the base plate 33 in a stepped manner with respect to an outer peripheral edge (both front and rear edge parts and both left and right edge parts) is formed in a substantially rectangular area of the side plate 35 excluding the outer peripheral edge. The squeezing portion 39 is a flat plate parallel to the base plate 33. A downward facing surface of the squeezing portion 39 is parallel to an inserting direction of the tab 51 into the terminal body 31.

The resilient plate 36 has a substantially rectangular shape long and narrow in the front-rear direction in a plan view, similar to the base plate 33. A left side of a front part of the resilient plate 36 is connected substantially at a right angle to a front part of the upper end of the left side plate 34L. The resilient plate 36 is cantilevered rearward and disposed to overlap on the outer surface (upper surface) of the supporting plate 35. The front part of the resilient plate 36 is in contact with or proximately facing the upper surface of a front part of the supporting plate 35, and an extending rear part 36E of the resilient plate 36 is in contact with or proximately facing the upper surface of a rear part of the supporting plate 35.

The resilient plate portion 36 is formed integrally with a resilient pressing portion 40. The resilient pressing portion 40 is disposed in a substantially central part (i.e. position corresponding to the pressure receiving portion 18 and the interference avoiding portion 23) of the terminal body 31 in the lateral direction. The resilient pressing portion 40 is disposed substantially in a central part of the resilient plate 36 in the front-rear direction and is formed by bending a part of the resilient plate 36 to project up toward the outer surface of the terminal body 31 and has a substantially trapezoidal shape in a side view. The upper surface of the resilient pressing portion 40 serves as a pressing surface 41 substantially parallel to the inserting direction of the female terminal fitting 30 into the terminal accommodation chamber 11.

The front surface of the resilient pressing portion 40 serves as an inserting tapered surface 42 inclined with respect to the front-rear direction. The inserting tapered surface 42 of the resilient pressing portion 40 is inclined up toward the rear, similar to the inserting tapered surface 22 of the housing 10. The rear surface of the resilient pressing portion 40 serves as a retaining tapered surface 43 inclined with respect to the front-rear direction. The retaining tapered surface 43 of the female terminal fitting 30 is inclined down toward the rear side, similar to the retaining tapered surface 21 of the housing 10.

The resilient pressing portion 40 is resiliently deformable to reduce a projecting distance from the upper surface (outer surface) of the resilient plate 36. With such a resilient deformation, both an angle of inclination of the inserting tapered surface 42 with respect to a plate surface of the resilient plate 35 and that of the retaining tapered surface 43 become smaller. Further, an area of the resilient plate 35 closer to a base end (front) than the resilient pressing portion 40 is not displaced in the front-rear direction, but an area thereof closer to an extending end (rear) than the resilient pressing portion 40 (area including the extending end part 36E) slides rearward while sliding in contact with the outer peripheral edge of the upper surface of the supporting plate 35.

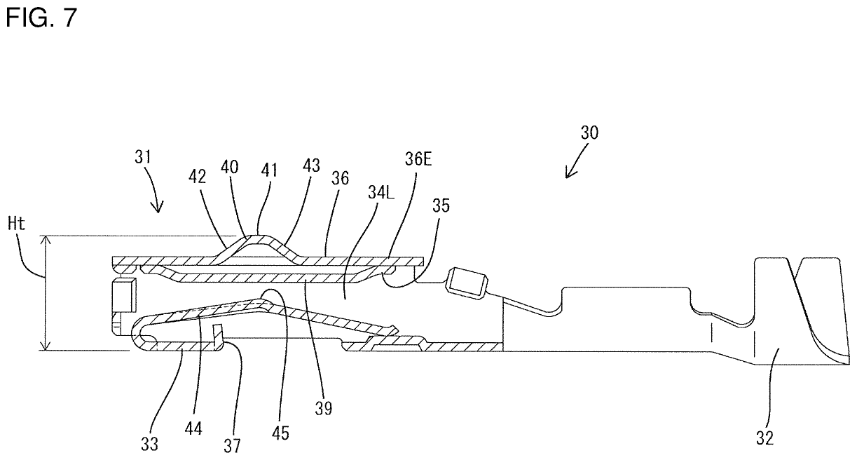

If the lower surface of the base plate 33 of the terminal body 31 is a basis in a state where the resilient pressing portion 40 is not resiliently deformed, a height Ht of the pressing surface 41 of the resilient pressing portion 40 is larger than the height Hb from the terminal receiving surface 16 to the pressure receiving surface 19 and smaller than the height Ha from the terminal receiving surface 16 to the non-interfering surface 24, as shown in FIGS. 2 and 7.

A resilient contact piece 44 is provided in the terminal body 31. The resilient contact piece 44 is folded to extend rearward from the front of the base plate 33. The resilient contact piece 44 has a chevron shape in a side view and a top part in a substantially central part of the resilient contact piece 44 in the front-rear direction serves as a contact point 45 closest to the squeezing portion 39. The resilient contact piece 44 is resiliently deformable to bring the contact point 45 away from the squeezing portion 39.

When the resilient contact piece 44 is in a free state without being resiliently deformed, an interval in the vertical direction between the upper surface of the contact point 45 and the lower surface of the squeezing portion 39 is smaller than a plate thickness of the tab 51. Thus, when the tab 51 inserted from the front of the housing 10 and passed through the tab insertion opening 14 into the terminal body 31, the tab 51 is sandwiched resiliently between the contact point 45 of the resilient contact piece 44 and the lower surface of the squeezing portion 39 so that the tab 51 and the resilient contact piece 44 are connected with a contact pressure due to a resilient restoring force of the resilient contact piece 44.

### <Functions and Effects of Embodiment>

Until the front end of the terminal body 31 comes into contact with the locking projection 17 in the process of inserting the female terminal fitting 30 into the terminal accommodation chamber 11, the lower surface of the female terminal fitting 30 slides in contact with the terminal receiving surface 16, the upper surface of the terminal body 31 slides in contact with the downward facing surface of the upper wall and the resilient pressing portion 40 is kept out of contact with the interference avoiding surface. When the female terminal fitting 30 is inserted farther from a state where the terminal body 31 is in contact with the locking projection 17, the locking lance 15 is displaced resiliently down due to the interference of the terminal body 31 and the locking projection 17. As the locking lance 15 resiliently returns, the lower surface of the terminal body 31 is separated from the terminal receiving surface 16 and the upper surface of the terminal body 31 slides in contact with the downward facing surface of the upper wall. At this time, the pressing surface 41 does not contact the non-interfering surface 24. Thus, the resilient pressing portion 40 is not deformed resiliently.

Thereafter, as shown in FIG. 2, the inserting tapered surface 42 of the resilient pressing portion 40 contacts the inserting tapered surface 22 of the retaining projection 20. At this time, the terminal body 31 and the locking projection 17 of the locking lance 15 are held in an interfering state. When the female terminal fitting 30 is inserted farther from this state, the resilient pressing portion 40 slips under the retaining projection 20 while being resiliently deformed to reduce a projecting height from the resilient plate 36. When the female terminal fitting 30 reaches a proper insertion position in the terminal accommodation chamber 11, the front end of the terminal body portion 31 butts against the front wall 13, the female terminal fitting 30 is stopped in front, the locking lance 15 resiliently returns to lock the locking projection 17 to the locking hole 37, and the female terminal fitting 30 is retained and held by this locking.

When the female terminal fitting 30 reaches the proper insertion position, the resilient pressing portion 40 finishes passing over the retaining projection 20. Thus, the resilient pressing portion 40 is displaced up due to a resilient restoring force thereof and the pressing surface 41 resiliently contacts the pressure receiving surface 19 due to a resilient force of the resilient pressing portion 40. By the resilient contact of the pressure receiving portion (pressing surface 41) with the pressure receiving portion 18 (pressure receiving surface 19), the female terminal fitting 30 is pressed against a terminal slide-contact surface and a relative displace thereof in the vertical direction (direction intersecting substantially at a right angle to the inserting direction of the female terminal fitting 30 into the terminal accommodation chamber 11) with respect to the housing 10 is restricted. Further, since the pressing surface 41 and the pressure receiving surface 19 are in surface contact, the inclination of the female terminal fitting 30 in the front-rear direction and lateral direction in the terminal accommodation chamber 11 also is restricted.

Further, with the female terminal fitting 30 properly inserted in the terminal accommodation chamber 11, the retaining tapered surface 43 of the resilient pressing portion 40 proximately faces the retaining tapered surface 21 of the retaining projection 20 from the front. Thus, when a rearward tensile force acts on the female terminal fitting 30, the female terminal fitting 30 is retained and held not only by the locking of the locking lance 15 and the locking hole 37, but also by the mutual locking of both retaining tapered surfaces 21, 43.

Further, in withdrawing the female terminal fitting 30 from the terminal accommodation chamber 11, a tool (not shown) is inserted into the housing 10 to displace the locking lance 15 down and disengage the locking projection 17 from the locking hole 37. The release of the locking lance 15 from the female terminal fitting 30 enables the female terminal fitting 30 to be withdrawn rearwardly from the housing 10 by exerting a rearward pulling force on the wire drawn out rearwardly of the housing 10. In withdrawing the female terminal fitting 30, the retaining tapered surface 43 of the resilient pressing portion 40 and the retaining tapered surface 21 of the retaining projection 20 come into contact, but the resilient pressing portion 40 can pass over the retaining projection 20 while being resiliently deformed since the retaining tapered surfaces 21, 43 are inclined with respect to a withdrawing direction of the female terminal fitting 30.

As described above, the connector F of this embodiment includes the housing 10 formed with the terminal accommodation chamber 11, and the rectangular tubular terminal body 31 of the female terminal fitting 30 can be inserted into the terminal accommodation chamber 11. The terminal accommodation chamber 11 is formed with the resiliently deflectable locking lance 15 configured to retain the female terminal fitting 30 in the terminal accommodation chamber 11 by locking the terminal body portion 31. The resilient contact piece 44 is provided inside the terminal body 31 and is configured to resiliently contact the tab 51 of the male terminal fitting 50 inserted into the terminal body 31. The resilient pressing portion 40 is formed on the outer surface of the terminal body 31, and the pressure receiving portion 18 on the inner wall of the terminal accommodation chamber 11 is configured such that the resilient pressing portion 40 is brought resiliently into contact with the resilient pressing portion 40. According to this configuration, the resilient pressing portion 40 of the terminal fitting resiliently contacts the pressure receiving portion 18 of the terminal accommodation chamber 11 to prevent vibration of the female terminal fitting 30 in the terminal accommodation chamber 11. A contact state of the resilient contact piece 44 and the tab 51 is stabilized in this way so that contact reliability is excellent.

Further, a contacting direction (upward direction in this embodiment) of the resilient pressing portion 40 with the pressure receiving portion 18 is substantially parallel to (substantially the same direction as) a contacting direction of the resilient contact piece 44 with the tab 51. According to this configuration, a contact pressure of the resilient contact piece 44 and the tab 51 is stabilized.

Further, the female terminal fitting 30 is inserted into the terminal accommodation chamber 11 from behind the housing 10, and the retaining projection 20 configured to lock the resilient pressing portion 40 with the properly inserted female terminal fitting 30 is adjacent to the rear end of the pressure receiving portion 18. According to this configuration, the female terminal fitting 30 is retained reliably by two locking means, i.e. the locking lance 15 and the retaining projection 20.

The interference avoiding portion 23 having a larger height difference from the retaining projection 20 than the pressure receiving portion 18 is formed in the area connected behind the retraining projection 20. According to this configuration, sliding resistance between the interference avoiding portion 23 and the resilient pressing portion 40 is reduced until the resilient pressing portion 40 comes into contact with the retaining projection 20 in the process of inserting the female terminal fitting 30 into the terminal accommodation chamber 11. Thus, work efficiency is good.

The resilient pressing portion 40 and the retaining projection 20 are locked via the retaining tapered surfaces 21, 43 inclined with respect to the inserting direction of the female terminal fitting 30. According to this configuration, the resilient pressing portion 40 and the retaining projection 20 are semi-locked. Thus, it is not necessary to use a tool or the like for disengaging the resilient pressing portion 40 from the retaining projection 20 when withdrawing the female terminal fitting 30 from the terminal accommodation chamber 11. Further, the inserting tapered surfaces 22, 42 inclined with respect to the inserting direction of the female terminal fitting 30 are formed on the rear surface of the retaining projection 20 and the front surface of the resilient pressing portion 40. According to this configuration, resistance when the resilient pressing portion 40 passes over the retaining projection 20 is reduced in the process of inserting the female terminal fitting 30.

Further, the terminal body 31 includes the base plate 33, the pair of side plates 34L, 34R rising substantially at a right angle from the both sides of the base plate 33, the resilient plate 36 and the supporting plate 35. The resilient plate 36 is connected to the front of the left side plate 34L in the front-rear direction, is cantilevered toward the other side in the front-rear direction substantially in parallel to the base plate 33, and is resiliently deformable. This resilient plate 36 is formed integrally with the resilient pressing portion 40. Further, the supporting plate 35 extends from the right side plate 34R substantially in parallel to the base plate 33 and supports the extending end part 36E of the resilient plate 36 from inside. According to this configuration, since the extending end part of the resilient plate 36 formed with the resilient pressing portion 40 is supported from inside by the supporting plate 35, a sufficient resilient pressing force of the resilient pressing portion 40 to the pressure receiving portion 18 can be ensured.

The invention is not limited to the above described and illustrated embodiment. For example, the following embodiments also are included in the scope of the invention.

Although the contacting direction of the resilient pressing portion with the pressure receiving portion is a direction substantially parallel to the contacting direction of the resilient contact piece with the tab in the above embodiment, the contacting direction of the resilient pressing portion may be a direction substantially perpendicular to the contacting direction of the resilient contact piece with the tab.

Although the tapered surfaces are formed on both the resilient pressing portion and the retaining projection in the above embodiment, the tapered surface may be formed on only either one of the resilient pressing portion and the retaining projection.

The resilient pressing portion and the retaining projection are locked via the tapered surfaces inclined with respect to the inserting direction of the female terminal fitting in the above embodiment. However, surfaces of the resilient pressing portion and the retaining projection substantially perpendicular to the inserting direction of the female terminal fitting may be locked to each other. In this case, the female terminal fitting can be withdrawn from the terminal accommodation chamber if a tool or the like for disengaging the resilient pressing portion from the retaining projection is used.

Although the retaining projection is formed on the inner wall of the terminal accommodation chamber in the above embodiment, the retaining projection may not be formed.

The interference avoiding portion having a larger height difference from the retaining projection than the pressure receiving portion is formed in the area behind the retaining projection in the above embodiment. However, such an interference avoiding portion may not be formed and the area behind the retaining projection may be at the same height as the pressure receiving portion.

Although the resilient plate is cantilevered rearward in the above embodiment, the resilient plate may be cantilevered forward.

Although the extending end part of the resilient plate is supported by the supporting plate in the above embodiment, the extending end part of the resilient plate may not be supported by the supporting plate.

Although the supporting plate supporting the extending end part of the resilient plate sandwiches the tab in cooperation with the resilient contact piece in the above embodiment, the supporting plate may not sandwich the tab in cooperation with the resilient contact piece.

### LIST OF REFERENCE SIGNS

F . . . connector
10 . . . housing
11 . . . terminal accommodation chamber
15 . . . locking lance
18 . . . pressure receiving portion
20 . . . retaining projection
21 . . . retaining tapered surface
22 . . . inserting tapered surface
23 . . . interference avoiding portion
30 . . . female terminal fitting
31 . . . terminal body
33 . . . base plate
34L . . . left side plate
34R . . . right side plate
35 . . . supporting plate
36 . . . resilient plate
36E . . . extending end part of resilient plate
39 . . . squeezing portion
40 . . . resilient pressing portion
42 . . . inserting tapered surface
43 . . . retaining tapered surface
44 . . . resilient contact piece
50 . . . male terminal fitting
51 . . . tab

1. A connector, comprising:
a housing formed with a terminal accommodation chamber;
a female terminal fitting including a terminal body in the form of a rectangular tube and to be inserted into the terminal accommodation chamber;
a resiliently deflectable locking lance formed in the terminal accommodation chamber and configured to retain the female terminal fitting in the terminal accommodation chamber by locking the terminal body;
a resilient contact piece provided inside the terminal body and configured to resiliently come into contact with a tab of a male terminal fitting inserted into the terminal body;
a resilient pressing portion formed on an outer surface of the terminal body; and
a pressure receiving portion formed on an inner wall of the terminal accommodation chamber and configured such that the resilient pressing portion is resiliently brought into contact therewith;
wherein:
the terminal body includes:
a base plate;
two side plates rising substantially at right angles from both side of the base plate;
a resiliently deformable resilient plate connected to one end part of one of the side plate in the front-rear direction and cantilevered toward the other end part in the front-rear direction substantially in parallel to the base plate; and
a supporting plate extending substantially parallel to the base plate from the other side plate and configured to support an extending end part of the resilient plate from inside; and
the resilient pressing portion is integrally formed to the resilient plate.

2. The connector of claim 1, wherein a contacting direction of the resilient pressing portion with the pressure receiving portion is a direction substantially parallel to a contacting direction of the resilient contact piece with the tab.

3. The connector of claim 2, wherein:
the female terminal fitting is inserted into the terminal accommodation chamber from behind the housing; and
a retaining projection configured to lock the resilient pressing portion with the female terminal fitting properly inserted is formed at a position adjacent to a rear end of the pressure receiving portion.

4. The connector of claim 3, wherein an interference avoiding portion having a larger height difference from the retaining projection than the pressure receiving portion is formed in an area connected behind the retaining projection.

5. The connector of claim 3, wherein the resilient pressing portion and the retaining projection are locked via a retaining tapered surface inclined with respect to an inserting direction of the female terminal fitting.

6. The connector of claim 3, wherein an inserting tapered surface inclined with respect to an inserting direction of the female terminal fitting is formed on at least one of a front surface of the resilient pressing portion and a rear surface of the retaining projection.

7. (canceled)
